(19) United States
(12) Patent Application Publication
(10) Pub. No.: US 2025/0288101 A1
(43) Pub. Date: Sep. 18, 2025

(54) SELF-CONTAINED MEDIA PRESENTATION SYSTEM FOR CONFERENCE AND TRADE SHOW APPLICATIONS

(71) Applicants: Jason Kraning, Greenville, SC (US); Robert Bass, Fountain Inn, SC (US)

(72) Inventors: Jason Kraning, Greenville, SC (US); Robert Bass, Fountain Inn, SC (US)

(21) Appl. No.: 19/071,948

(22) Filed: Mar. 6, 2025

Related U.S. Application Data
(60) Provisional application No. 63/564,795, filed on Mar. 13, 2024.

(51) Int. Cl. A47B 83/00; A47B 21/04; A47B 83/04; G03B 21/58

(52) U.S. Cl. CPC A47B 83/001; A47B 21/04; A47B 83/045; G03B 21/58

(57) ABSTRACT

A self-contained media presentation system comprising a crate having a frame mounted on a floor panel; a series of castor wheels by the floor panel; a wheel protection frame disposed around each castor wheel; a front panel, rear panel, a first side panel, a second side panel, and lid panel carried by the frame, wherein the lid is pivotally attached to the top of the frame and the rear panel is removable; a primary divider extending from the first side panel to the second side panel and defining a first storage area for storing at least a projector screen and stand; a pair of interior walls extend from the primary divider to the rear panel defining a projector storage area; and, a projector assembly removably carried in the projector storage area for cooperating with the projector screen when deployed from the first storage area to display visual media.

### BACKGROUND OF THE INVENTION

### 1) Field of the Invention

The present invention relates to a media presentation system, and more particularly, to a shipping case that contains necessary items for and converts into a trade show exhibitor booth with video presentation capability.

### 2) Description of Related Art

Setting up a trade show exhibitor booth involves a variety of structural and medial presentation systems. A given exhibitor booth may typically include tables, chairs, printed materials, banners, one or more video projectors, and display screens. These items are typically shipped in large creates that are loaded and unloaded by the booth operator. A problem arises, however, in efficiently taking down an exhibitor booth when having to wait for the shipping creates to arrive after a show has ended, leading to missed flights and lost shipping materials.

Accordingly, it is an object of the present invention to provide a self-contained media presentation system for conference and trade show applications wherein the exhibitor can convert the shipping container into the booth and then pack everything back into the shipping container immediately at the conclusion of the show.

### SUMMARY OF THE INVENTION

The above objectives are accomplished according to the present invention by providing a shipping container comprising a self-contained media presentation system designed for conference and trade show environments. Since the self-contained media presentation system is a trade show shipping case that converts into a trade show booth, it is specifically designed to accomplish two unique tasks. First, since the shipping case is the booth, the trade show attendant will never have to wait hours for their shipping container to arrive when the convention is over saving them from the stress of missing flights or lost/missing shipping containers. Second, the shipping case contains a 4k ultra short throw high-definition projection system that broadcasts a 160″ diagonal image to a 10′×8′ light enhancing projection surface. The projection surface, chairs, brochures, and case cover are all in one unit. The case cover is a branded graphic fabric that covers over a portion of the crate to customize the vendor space with selected branding. The unit is also wi-fi and Bluetooth capable with imbedded camera systems so the life size video image can not only show product but can be used for video conferencing meetings and can even have the booth manned digitally by an off-site attendant. Each mobile self-contained media presentation system of the present invention supports a 10′×10′ booth space. Multiple units can be seamlessly daisy chained together for larger booths.

In one embodiment of the present invention, a self-contained media presentation system is provided for conference and trade show applications, comprising: A self-contained media presentation system comprising a crate having a frame mounted on a floor panel; a series of castor wheels disposed on a bottom side of said floor panel; a front panel, rear panel, first side panel, second side panel, and lid panel carried by said frame, wherein said lid panel is pivotally attached to a top of said frame; a primary divider extending from said first side panel to said second side panel and defining a first storage area; a projector assembly removably carried in said crate; and a projector screen storable within said first storage area and deployable for cooperation with said projector assembly to display visual media, wherein said crate serves as both a shipping container and a structural element of a trade show booth when said projector assembly and projector screen are deployed.

In a further advantageous embodiment, a wheel protection frame is disposed around each bottom corner of said floor panel for protecting said castor wheels.

In a further advantageous embodiment, said rear panel is removable for exposing an interior of said crate.

In a further advantageous embodiment, a pair of interior walls extends from said primary divider to said rear panel defining a projector storage area.

In a further advantageous embodiment, said projector assembly is removably carried in said projector storage area.

In a further advantageous embodiment, a base plate is carrying said projector assembly, wherein said base plate is slotted into a series of receiving rails disposed with said projector storage area of said crate.

In a further advantageous embodiment, a riser portion is disposed on a bottom side of said base plate for elevating the projector when placed on the ground.

In a further advantageous embodiment, a pair of secondary storage compartments is defined on opposite sides of said projector storage area.

In a further advantageous embodiment, at least one of said secondary storage compartments includes an internal storage shelf.

In one embodiment, the above objectives are accomplished according to the present invention by providing a mobile trade show booth system comprising a crate having a frame mounted on a floor panel; a series of castor wheels disposed on a bottom side of said floor panel; a front panel, rear panel, a first side panel, a second side panel, and lid panel carried by said frame, wherein said lid is pivotally attached to a top of said frame and said rear panel is removable for exposing an interior of said crate; a primary divider extending from said first side panel to said second side panel and defining a first storage area between said front panel and said primary divider for storing at least a projector screen and stand; a pair of interior walls extend from said primary divider to said rear panel defining a projector storage area; a projector assembly removably carried in said projector storage area for cooperating with said projector screen when deployed from said first storage area to display visual media; and, a pair of secondary storage compartments defined on opposite sides of the projector storage area and including at least one internal storage shelf; a wireless communications device and at least one camera device included in said crate being operatively associated with said projector assembly; whereby said projector screen, projector assembly, and camera can be deployed from said crate to provide an interactive video display capable of allowing a user to remotely operate and interact with passersby such that said crate serves as both a shipping container and a structural element of said trade show booth when said projector assembly and projector screen are deployed.

In a further advantageous embodiment, a wheel protection frame is disposed adjacent each of said castor wheels.

In a further advantageous embodiment, a castor wheel is carried at each corner of said floor panel and said wheel protection frame extends around each bottom corner of said floor panel for protecting said castor wheels.

In a further advantageous embodiment, said removable rear panel is storable in said first storage area when removed.

In a further advantageous embodiment, a branded graphic wrap is provided for customizing said mobile crate as part of a trade show booth.

In a further advantageous embodiment, a camera device is operatively associated with said projector assembly, enabling remote operation and interaction with passersby when said trade show booth is deployed.

In a further advantageous embodiment, a base plate is carrying said projector assembly, wherein said base plate is slotted into a series of receiving rails disposed with said projector storage area of said crate.

In a further advantageous embodiment, a riser portion disposed on a bottom side of said base plate for elevating the projector when placed on the ground.

In one embodiment, the above objectives are accomplished according to the present invention by providing a method of deploying a self-contained media presentation system for a trade show booth exhibit, comprising transporting a crate to a presentation location, said crate having a frame mounted on a floor panel with castor wheels; opening a pivotally attached lid panel of said crate; removing a rear panel of said crate to expose an interior of said crate; removing a projector assembly from within said crate, wherein removing said projector assembly comprises sliding a base plate carrying said projector assembly out of receiving rails within said crate; removing a projector screen from a first storage area within said crate; setting up said projector screen; positioning said projector assembly to project visual media onto said projector screen; and, connecting said projector assembly to a wireless communications device and a camera device to enable remote operation and interaction with passersby.

In a further advantageous embodiment, the method includes storing said rear panel within a designated storage space in said crate after removal.

In a further advantageous embodiment, the method includes positioning said base plate on a floor between said crate and said projector screen.

### BRIEF DESCRIPTION OF THE DRAWINGS

The system designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a rear perspective view of the self-contained media presentation system in an open arrangement according to the present invention;

FIG. 2 shows a rear perspective view of an internal frame structure of the self-contained media presentation system according to the present invention;

FIG. 3 shows a rear perspective view of the self-contained media presentation system in a closed arrangement according to the present invention;

FIG. 4 shows a rear perspective view of the self-contained media presentation system with an open lid according to the present invention;

FIG. 5 shows a rear perspective view of the self-contained media presentation system with an open lid and rear panel removed according to the present invention;

FIG. 6 shows a rear perspective view of the self-contained media presentation system with an open lid and the rear panel removed and stored within the crate according to the present invention;

FIG. 7 shows a rear perspective view of the self-contained media presentation system with a closed lid, the rear panel removed, and the projector assembly removed according to the present invention;

FIG. 8 shows a side view of the self-contained media presentation system in a deployed configuration according to the present invention;

FIG. 9 shows a front perspective view of the self-contained media presentation system in a deployed configuration according to the present invention;

FIGS. 10a-10d shows a top, front, rear, and side view, respectively, of the self-contained media presentation system according to the present invention; and,

FIGS. 11a-1c shows a top, rear, and side view, respectively, of the self-contained media presentation system according to the present invention.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

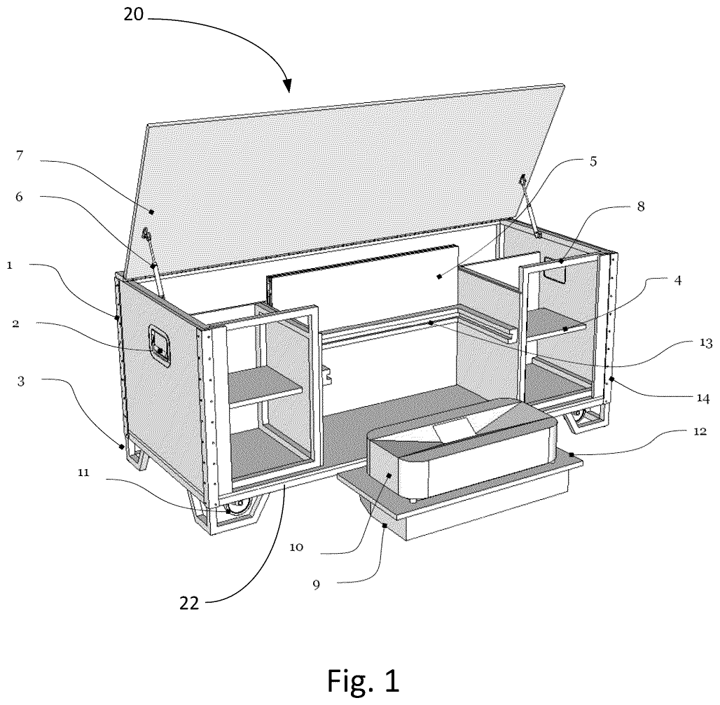

Referring to the example embodiment illustrated in FIGS. 1-11c, the self-contained media presentation system, designated generally as 20, of the present invention is a product engineered to deliver a fully integrated trade show exhibitor experience in one package. A specially designed steel framed crate is shipped LTL freight to a convention hall and contains all the items to produce a robust visual media presentation on a 10′ wide×8′ tall hi-resolution screen from an Ultra Short Throw (UTS) video projector. The crate is then wrapped in a stretch fabric graphic presentation as part of the trade show display customer branding.

Referring to FIG. 1, the self-contained media presentation system includes a crate 22 for the storage and transportation of the exhibitor materials. In particular, the crate is constructed and arranged to removably house a projector and display screen, as well as other items such as chairs, printed materials, and other electronic components such as wireless communications devices for setting up a trade show exhibitor booth in which the crate forms a part of the booth.

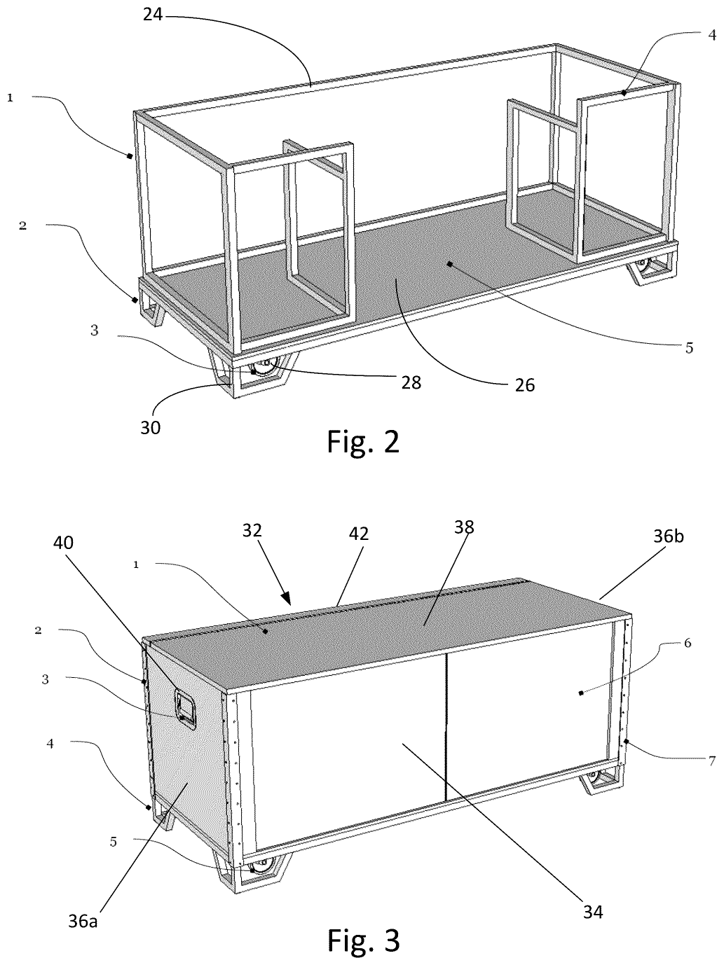

Referring to FIG. 2, the crate 22 includes a frame 24, preferably a steel frame, mounted on a floor 26. In one embodiment, the floor 26 is a high density plastic extrusion floor approximately ½″ thick to support the frame 24 and related components that define the crate 22. Preferably, a series of castor wheels 28 are disposed on a bottom side of floor 26 to provide mobility to the crate 22. To help protect the castor wheels from damage, a wheel protection frame 30 is disposed around each bottom corner of the floor 26.

Referring to FIG. 3, and 10a-10d, frame 24 carries a series of external panels including a front panel 32, removable rear panel 34, end/side panels 36a and 36b, and a hinged lid panel 38 that opens. In the illustrated embodiment, side panels 36a and 36b each include a recessed handle 40 to help with moving the crate. In FIG. 3, the crate is shown in a fully closed arrangement.

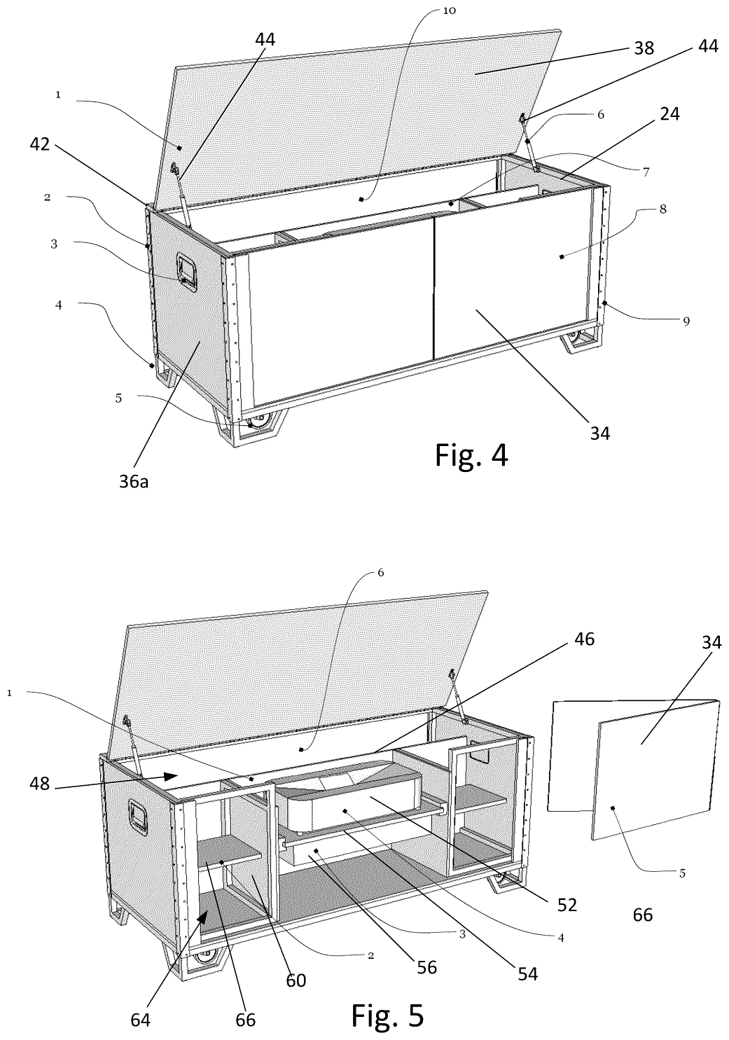

Referring to FIGS. 4-8, and 11a-11c crate 22 is shown transitioning from the closed arrangement to an open arrangement to deploy the projector assembly and display screen contained therein, among other items that may be contained in the crate. Referring to FIG. 4, the lid 38 is pivotally carried on a top side of frame 24. A first side of lid 38 is hinged to a fixed rail 42 on the top side of frame 24 to allow the lid to be operated between a closed position (FIG. 3) and an open position as in FIG. 4. In the illustrated embodiment, a pair of strut arms 44 interconnect a bottom side of lid 38 to frame 24 to assist with opening and closing of the lid.

Referring to FIG. 5, rear panel 34 is removable to further expose the interior storage areas of the crate 22. The interior of crate 22 includes a primary divider 46 that extends from side panel 36a to side panel 36b and defines a first storage area 48 between front panel 32 and the divider 46. First storage area 48 is constructed and arranged to carry at least a projector screen and stand. The projector screen being 10′×8′ in dimensions. Additionally, items like chairs may also be stored in this first storage area.

Further, between primary divider 46 and rear panel 34 is a removable projector assembly 50. The removable projector assembly includes a projector unit 52, preferably an ultra short throw projector, carried on a removable base plate 54. In the illustrated embodiment, base plate 54 includes a riser portion 56 for elevating the projector when placed on the ground. Base plate 54 is slidably carried in receiving rails 58a and 58b mounted to interior walls 60. Thus, base plate 54 can slide out to remove the projector unit 52 from crate 22 and then slide back into the rails 58 for storage of the projector unit. Interior walls 60 extend from primary divider 46 to rear panel 34 to define a projector storage area 62. On opposite sides of the projector storage area 62, secondary storage compartments 64 are provided that can include at least one internal storage shelf 66.

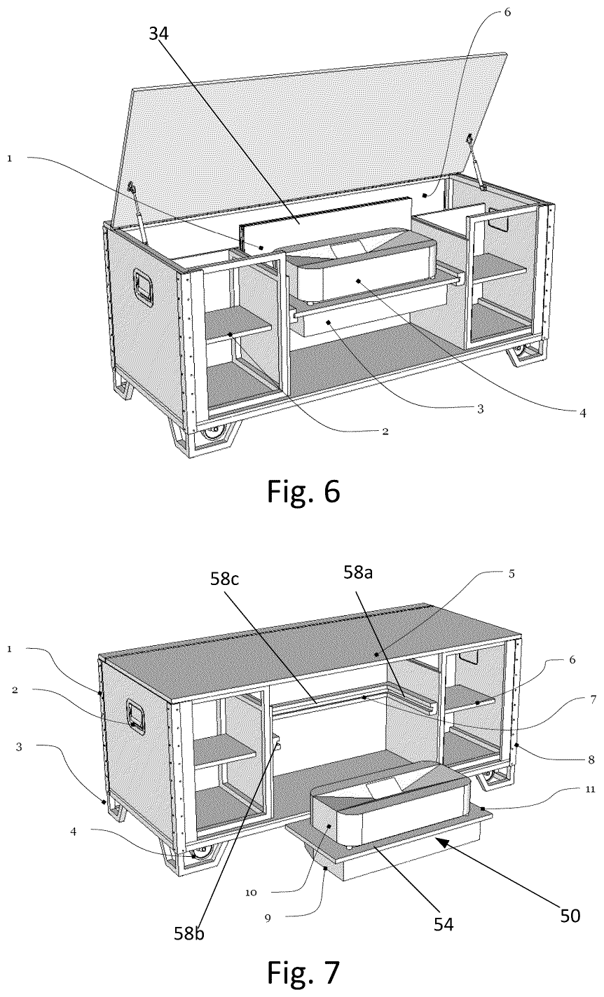

Referring to FIGS. 5 and 6, rear panel 34 is foldable and stored in a designated panel storage space behind projector assembly 50 and adjacent primary divider 64. This helps keep the panel out of the way when the crate is opened for the exhibitory display.

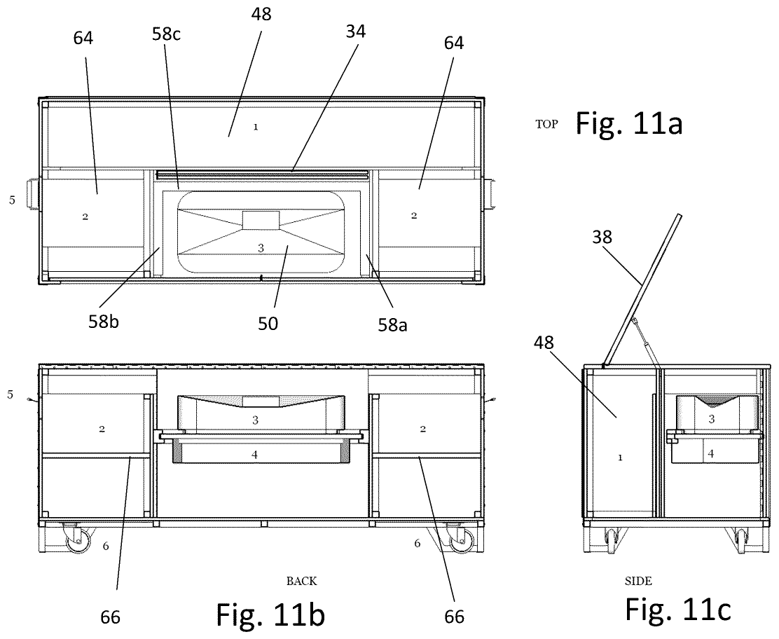

Referring to FIG. 7, projector assembly 50 is shown removed from projector storage area 62 for projection to the screen. A securing rail 58c extends between receiving rails 58a and 58b. When rear panel 34 is not in use, it is stored behind projector assembly 50 between securing rail 58c and primary divider 46 (as best shown in FIGS. 1 and 11a). Base plate 54 slots into securing rail 58c, together with receiving rails 58a and 58b to help hold the projector assembly in place during transport.

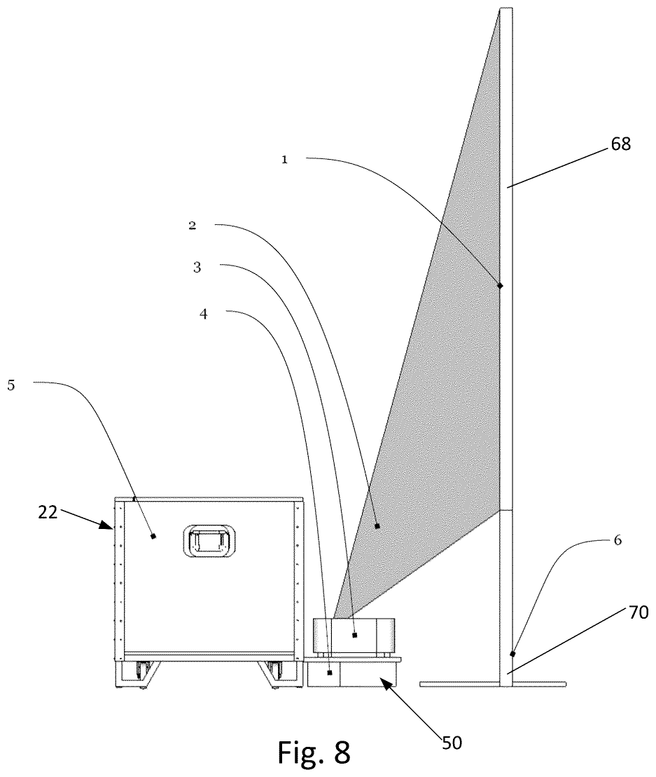

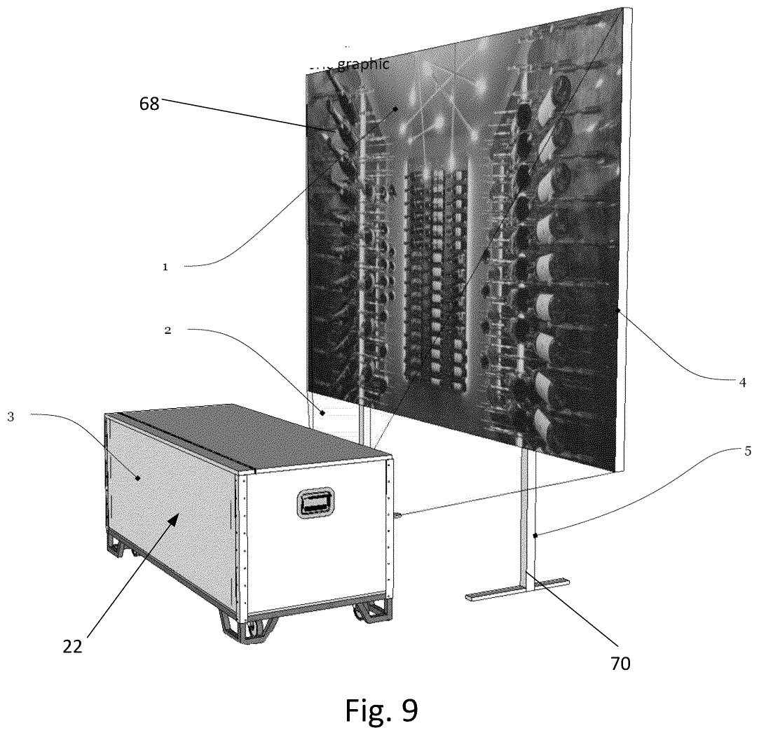

Referring to FIGS. 8 and 9, the projector screen 68 and stand 70 are shown deployed with the projector assembly positioned on the floor between the crate 22 and screen 68. Once the display is finished, the screen and stand are returned to first storage area 48, the projector assembly returned to the projector storage area 62, lid 38 closed and rear panel 34 reinstalled to place the crate in a closed arrangement ready for transport.

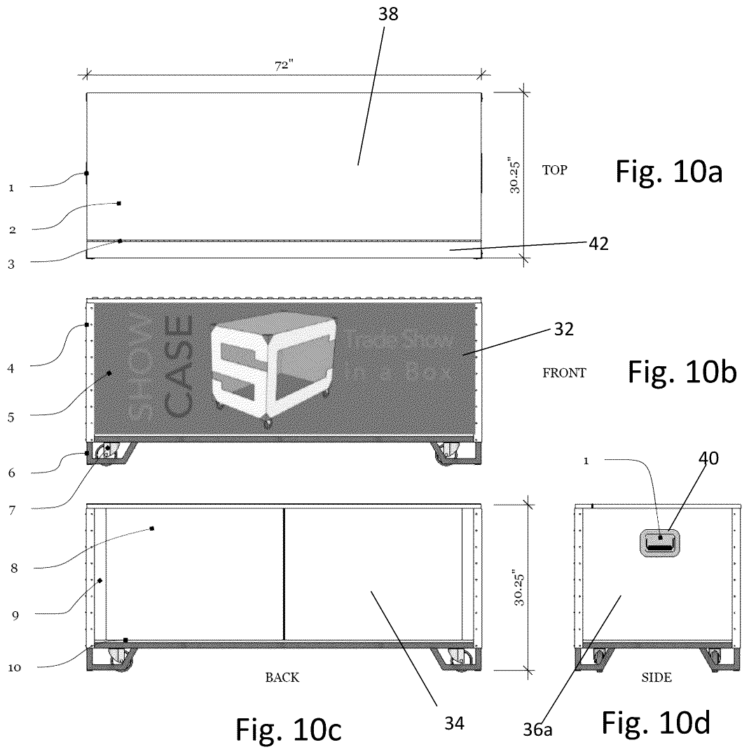

Referring to FIG. 10b, the front, side, rear and top panels can all be wrapped or otherwise decorated for promotion of the goods or services.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A self-contained media presentation system, comprising:
a crate having a frame mounted on a floor panel;
a series of castor wheels disposed on a bottom side of said floor panel;
a front panel, rear panel, first side panel, second side panel, and lid panel carried by said frame, wherein said lid panel is pivotally attached to a top of said frame;
a primary divider extending from said first side panel to said second side panel and defining a first storage area;
a projector assembly removably carried in said crate; and
a projector screen storable within said first storage area and deployable for cooperation with said projector assembly to display visual media, wherein said crate serves as both a shipping container and a structural element of a trade show booth when said projector assembly and projector screen are deployed.

2. The self-contained media presentation system of claim 1, further comprising a wheel protection frame disposed around each bottom corner of said floor panel for protecting said castor wheels.

3. The self-contained media presentation system of claim 1, wherein said rear panel is removable for exposing an interior of said crate.

4. The self-contained media presentation system of claim 1, further comprising a pair of interior walls extending from said primary divider to said rear panel defining a projector storage area.

5. The self-contained media presentation system of claim 4, wherein said projector assembly is removably carried in said projector storage area.

6. The self-contained media presentation system of claim 5, including a base plate carrying said projector assembly, wherein said base plate is slotted into a series of receiving rails disposed with said projector storage area of said crate.

7. The self-contained media presentation system of claim 6, including a riser portion disposed on a bottom side of said base plate for elevating the projector when placed on the ground.

8. The self-contained media presentation system of claim 1, further comprising a pair of secondary storage compartments defined on opposite sides of said projector storage area.

9. The self-contained media presentation system of claim 6, wherein at least one of said secondary storage compartments includes an internal storage shelf.

10. A mobile trade show booth system, comprising:
a crate having a frame mounted on a floor panel;
a series of castor wheels disposed on a bottom side of said floor panel;
a front panel, rear panel, a first side panel, a second side panel, and lid panel carried by said frame, wherein said lid is pivotally attached to a top of said frame and said rear panel is removable for exposing an interior of said crate;
a primary divider extending from said first side panel to said second side panel and defining a first storage area between said front panel and said primary divider for storing at least a projector screen and stand;
a pair of interior walls extend from said primary divider to said rear panel defining a projector storage area;
a projector assembly removably carried in said projector storage area for cooperating with said projector screen when deployed from said first storage area to display visual media; and,
a pair of secondary storage compartments defined on opposite sides of the projector storage area and including at least one internal storage shelf;
a wireless communications device and at least one camera device included in said crate being operatively associated with said projector assembly;
whereby said projector screen, projector assembly, and camera can be deployed from said crate to provide an interactive video display capable of allowing a user to remotely operate and interact with passersby such that said crate serves as both a shipping container and a structural element of said trade show booth when said projector assembly and projector screen are deployed.

11. The mobile trade show booth system of claim 10, including a wheel protection frame disposed adjacent each of said castor wheels.

12. The mobile trade show booth system of claim 11, wherein a castor wheel is carried at each corner of said floor panel and said wheel protection frame extends around each bottom corner of said floor panel for protecting said castor wheels.

13. The mobile trade show booth system of claim 10, wherein said removable rear panel is storable in said first storage area when removed.

14. The mobile trade show booth system of claim 10, further comprising a branded graphic wrap for customizing said mobile crate as part of a trade show booth.

15. The mobile trade show booth system of claim 10, further comprising a camera device operatively associated with said projector assembly, enabling remote operation and interaction with passersby when said trade show booth is deployed.

16. The mobile trade show booth system of claim 10, including a base plate carrying said projector assembly, wherein said base plate is slotted into a series of receiving rails disposed with said projector storage area of said crate.

17. The mobile trade show booth system of claim 16, including a riser portion disposed on a bottom side of said base plate for elevating the projector when placed on the ground.

18. A method of deploying a self-contained media presentation system for a trade show booth exhibit, comprising:
transporting a crate to a presentation location, said crate having a frame mounted on a floor panel with castor wheels;
opening a pivotally attached lid panel of said crate;
removing a rear panel of said crate to expose an interior of said crate;
removing a projector assembly from within said crate, wherein removing said projector assembly comprises sliding a base plate carrying said projector assembly out of receiving rails within said crate;
removing a projector screen from a first storage area within said crate;
setting up said projector screen;
positioning said projector assembly to project visual media onto said projector screen; and,
connecting said projector assembly to a wireless communications device and a camera device to enable remote operation and interaction with passersby.

19. The method of claim 18, further comprising storing said rear panel within a designated storage space in said crate after removal.

20. The method of claim 18, further comprising positioning said base plate on a floor between said crate and said projector screen.
